(19) United States
(12) Patent Application Publication
(10) Pub. No.: US 2021/0078045 A1
(43) Pub. Date: Mar. 18, 2021

(54) PARCEL IDENTIFICATION APPARATUS AND PARCEL SORTING APPARATUS

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventor: Hengbin ZHU, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/959,902

(22) PCT Filed: Jan. 4, 2019
(86) PCT No.: PCT/CN2019/070391

§ 371 Date: Jul. 2, 2020

(30) Foreign Application Priority Data
Jan. 4, 2018 (CN) 201820011616.2

(51) Int. Cl. B07C 3/18; B07C 3/14; B25J 19/02

(52) U.S. Cl. CPC B07C 3/18; B25J 19/02; B07C 3/14

(57) ABSTRACT

A parcel identification apparatus and a parcel sorting apparatus are disclosed. The parcel identification apparatus includes a pickup device including a pickup portion for picking up and holding a to-be-identified parcel, and a first identification device disposed on the pickup portion, where the first identification device identifies parcel information on a side that is of the to-be-identified parcel and that faces towards the pickup portion; and a second identification device disposed outside the pickup device, where the second identification device configured identifies parcel information on other sides that are of the to-be-identified parcel and that are other than the side facing towards the pickup portion. The parcel identification apparatus and the parcel sorting apparatus automatically identifies the parcel information without manual intervention in a parcel information identification step of a parcel sorting process.

### CROSS-REFERENCE TO RELATED APPLICATIONS

This application is based upon and claims priority to Chinese Patent Application No. 201820011616.2, filed on Jan. 4, 2018, the entire contents of all of which are incorporated herein by reference.

### TECHNICAL FIELD

The present disclosure relates to the technical field of parcel identification and sorting, and in particular, to a parcel identification apparatus and a parcel sorting apparatus.

### BACKGROUND

In a modern intelligent logistics system, using an automation technology to improve production efficiency has been a mainstream development trend. Currently, the latest sorting mode of a parcel sorting center is to replace manual handling and delivery of a parcel with an automated guided vehicle (AGV, Automated Guided Vehicle). This sorting mode is highly efficient and saves a lot of labor costs.

Only the identification codes of a parcel with upward identification codes may be scanned to read the corresponding sorting station information thereof by a scanner on a portal frame; therefore, a very important step in a sorting process is to manually take the parcel from a conveyance line, and then manually place a parcel side with the identification codes upward on the automated guided vehicle, so that the identification codes are automatically scanned and when the automated guided vehicle passes through the scanner, and the parcel information is obtained, and then the parcel is conveyed to a corresponding sorting outlets according to the parcel information.

During the implementation of the present disclosure, an inventor found that: a parcel identification apparatus in the prior art may only scan a parcel placed properly, it is necessarily placed manually to make the bar codes thereof face towards the scanner, and the parcel identification apparatus has low efficiency.

### SUMMARY

The present disclosure provides a parcel identification apparatus and a parcel sorting apparatus, to automatically identify parcel information in a parcel information identification step.

According to a first aspect, the present disclosure discloses a parcel identification apparatus. The parcel identification apparatus includes: a pickup device including a pickup portion for picking up and holding a to-be-identified parcel, and a first identification device disposed on the pickup portion, where the first identification device configured to at least identify parcel information on a side that is of the to-be-identified parcel and that faces towards the pickup portion; and a second identification device disposed outside the pickup device, where the second identification device configured to at least identify parcel information on other sides that are of the to-be-identified parcel and that are other than the side facing towards the pickup portion.

In some embodiments, the pickup device configured enable the position of the to-be-identified parcel held by the pickup portion to be changed, so that the parcel information on the other sides is identified by the second identification device.

In some embodiments, the pickup portion is rotatable around the axis thereof and/or the pickup portion is rotatable around an external axis as a whole, to change the position of the to-be-identified parcel held by the pickup portion.

In some embodiments, the first identification device faces towards a holding position where the pickup portion holds the to-be-identified parcel; and/or the first identification device is disposed at the middle of the pickup portion.

In some embodiments, the pickup device includes a robot, and the pickup portion is a manipulator connected to an arm end of the robot.

In some embodiments, the robot is a six-axis robot.

In some embodiments, the second identification device includes two external identification units, each of which independently identifies parcel information; and the first identification device and the two external identification units constitute three vertexes of an acute-angled triangle.

In some embodiments, the first identification device and/or the second identification device include (s) a scanner for scanning identification codes.

According to a second aspect, the present disclosure provides a parcel sorting apparatus, including the parcel identification apparatus according to any one in the first aspect of the present disclosure, where the parcel identification apparatus is disposed at a sorting inlet of the parcel sorting apparatus, so as to pick up the parcel at the sorting inlet and identify the parcel information therein.

In some embodiments, the parcel sorting apparatus includes a sorting platform, and an automated guided vehicle disposed on the sorting platform; the sorting platform includes the sorting inlet and a plurality of sorting outlets, and the automated guided vehicle receives a parcel held by the pickup device and transports the received parcel to a corresponding sorting outlet according to the parcel information of the received parcel identified by the first identification device and/or the second identification device.

The parcel identification apparatus and the parcel sorting apparatus are provided based on the present disclosure; in the parcel identification apparatus, a first identification device disposed on a pickup portion of a pickup device may automatically identify parcel information on a side that is of a to-be-identified parcel and that faces towards the pickup portion; and a second identification device disposed outside the pickup device may automatically identify parcel information on other sides that are of the to-be-identified parcel and that are other than the side facing towards the pickup portion. Therefore, the parcel identification apparatus enables parcel identification codes to face towards the identification apparatus without manual intervention in a parcel information identification step of a parcel sorting process, thereby automatically identifying the parcel information. The parcel sorting apparatus applying the parcel identification apparatus may automatically identify the parcel information, thereby facilitating automation of parcel sorting.

The exemplary embodiments of the present disclosure are described in detail with reference to the accompanying drawings, so that other features and advantages of the present disclosure will become apparent.

### DESCRIPTION OF DRAWINGS

The drawings described herein are used to further understand the present disclosure and constitute a part of this application; and the schematic embodiments of the present disclosure and the description thereof are used to explain the present disclosure and do not constitute improper limitations to the present disclosure. In the accompanying drawings:

FIG. 1 is a schematic structural diagram of a parcel identification apparatus according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are only some but not all of the embodiments of the present disclosure. Actually, the following description of at least one exemplary embodiment is merely illustrative, which is not intended for limiting the present disclosure, and the application or use thereof. All other embodiments obtained by persons of ordinary skill in the art based on the embodiments of the present disclosure without creative efforts shall fall within the protection scope of the present disclosure.

Unless otherwise specified, relative arrangements of components and steps, numerical expressions and values set forth in these embodiments do not limit the scope of the present disclosure. At the same time, it should be understood that for the convenience of description, the dimensions of various portions shown in the accompanying drawings are not drawn according to the actual proportional relation. Technologies, methods, and equipment known to persons of ordinary skill in the related art may not be discussed in detail, but where appropriate, they should be considered as a part of the authorized specification. In all examples shown and discussed herein, all specific values should be explained merely as being exemplary but not a limitation. Therefore, other examples of exemplary embodiments may have different values. It should be noted that similar sign numbers and letters indicate similar items in the following accompanying drawings. Therefore, once a specific item is defined in one of the accompanying drawings, a further discussion is not required for it in the subsequent drawings.

For the convenience of description, spatial relative terms such as “on”, “above”, “on the upper surface of” and “over” may be used herein to describe the spatial positional relation between one component or the feature thereof and other components or the features thereof, as shown in the FIGURE. It should be understood that in addition to component orientations described in the FIGURE, the spatial relative terms are intended to encompass different orientations in use or operation. For example, if being inverted, the component in the accompanying drawing is described as “above either other components or configurations” and positioned “below either other components or configurations” or “under other components or configurations”. Thus, exemplary terms “above” may include two orientations of “above” and “below”. The component may also be positioned in other different ways (with a rotation angle of 90 degrees or in other orientations), and spatial relative descriptions used herein are explained accordingly.

An embodiment of the present disclosure provides a parcel identification apparatus and a parcel sorting apparatus.

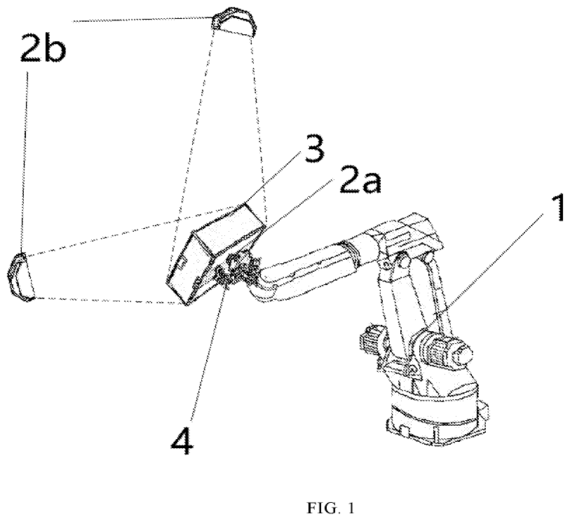

As shown in FIG. 1, the parcel identification apparatus includes, the pickup device includes a pickup portion 4 for picking up and holding a to-be-identified parcel 3 and a first identification device 2a disposed on the pickup portion 4, where the first identification device 2a is used to at least identify parcel information on a side that is of the to-be-identified parcel and faces towards the pickup portion 4. The parcel identification apparatus further includes a second identification device disposed outside the pickup device, where the second identification device is used to at least identify parcel information on other sides that are of the to-be-identified parcel and that are other than the side facing towards the pickup portion 4.

In the parcel identification apparatus, the first identification device 2a disposed on the pickup portion of the pickup device may automatically identify parcel information on a side that is of a to-be-identified parcel 3 and that faces towards the pickup portion 4; and the second identification device disposed outside the pickup device may automatically identify parcel information on other sides that are of the to-be-identified parcel 3 and that are other than the side facing towards the pickup portion. No matter how the parcel is placed in a parcel information identification step, the parcel identification apparatus enables the parcel to be identified by the first identification device 2a and the second identification device, so that there is no manual intervention which places the parcel identification codes to face towards the identification apparatus, thus the parcel information is automatically identified.

In some preferable embodiments, the pickup device enables the position of the to-be-identified parcel 3 held by the pickup portion 4 to be changed, so that the parcel information on the other sides may be identified by the second identification device. This is advantageous to enable the first identification device 2a and the second identification device to scan without a blind region, thereby improving the success rate of parcel information identification.

The parcel sorting apparatus according to the embodiment of the present disclosure includes the foregoing identification apparatus, and may automatically identify parcel information, thereby facilitating automation of parcel sorting.

The parcel identification apparatus and the parcel sorting apparatus according to this embodiment are further described below with reference to FIG. 1.

As shown in FIG. 1, in this embodiment, the pickup device includes a pickup portion 4 for picking up and holding a to-be-identified parcel 3, and a first identification device 2a disposed on a pickup portion 4. The first identification device 2a may identify parcel information on a side that is of the to-be-identified parcel and that faces towards the pickup portion.

In this embodiment, the pickup portion 4 is a manipulator or may also be other members with the functions of picking up and holding the parcel, such as a clamping jaw member, a hooking member and a sucker member.

The to-be-identified parcel 3 may have identification codes for identification, such as QR codes and bar codes.

When the pickup device picks up or holds the to-be-identified parcel 3, the first identification device 2a may identify parcel information on a side that is of the to-be-identified 3 and that faces towards the pickup portion 4. In the process of picking up and holding the to-be-identified parcel 3 by the pickup device, the second identification device may identify parcel information on other sides of the to-be-identified parcel.

In this embodiment, the pickup device enables the position of the to-be-identified parcel 3 held by the pickup portion 4 to be changed, so that the parcel information on the other sides may be identified by the second identification device.

Because all sides of the parcel may be identified by the first identification device 2a and the second identification device, the parcel information regardless of being on any side of the to-be-identified parcel may be identified by the first identification device 2a and the second identification device. The identified parcel information may be transmitted to a controller, and the controller carries out subsequent parcel sorting steps according to the parcel information.

In some embodiments, the first identification device 2a faces towards a holding position where the pickup portion 4 holds the to-be-identified parcel 3. The pickup portion 4 picks up and holds the to-be-identified parcel in a contact manner, a position where the pickup portion 4 is in contact with the parcel forms a holding place, and a holding position is a region surrounded by a plurality of holding places. The first identification device 2a faces towards the holding position. This is beneficial to improve the identification accuracy and efficiency of the first identification device 2a in identifying parcel information on a side that is of the to-be-identified parcel 3 and that is opposite to the pickup portion 4.

In some embodiments, the first identification device 2a is disposed at the middle of the pickup portion 4. This enables an angle formed by the first identification device 2a and the identification codes location to be within a suitable scope when the first identification device 2a identifies the parcel information of the to- be-identified parcel 3, thereby preventing the first identification device 2a from excessively far away from the identification codes, and being beneficial to improve the identification accuracy and efficiency thereof.

In some preferable embodiments, the pickup portion 4 may rotate around the axis thereof and/or the pickup portion 4 may rotate around an external axis as a whole, to change the position of the to-be-identified parcel 3 held by the pickup portion 4.

In some embodiments, the pickup device includes a robot, and the pickup portion 4 is a manipulator connected to an arm end of the robot. The robot is a six-axis robot 1 in some embodiments.

In this embodiment, the manipulator may rotate around the axis thereof at the arm end of the robot, or may rotate around the external axis as each joint of the six-axis robot 1 rotates.

The six-axis robot 1 includes a plurality of rotating shafts, having a plurality of freedom degrees in the spatial movement thereof. The manipulator of the six-axis robot 1 is used for the pickup portion 4, and may be rotated and displaced in different directions when picking up the to-be-identified parcel 3, to meet the needs of the pickup direction and angle of the to-be-identified parcel 3 and accurately and flexibly pick up the parcel 3; at the same time, the flexible position change of the to-be-identified parcel may be well adapted for the second identification device to detect a plurality of sides of the to-be-identified parcel 3.

In some embodiments, the second identification device includes two external identification units 2b. Each one of external identification units 2b may individually identify parcel information. The first identification device 2a and the two external identification units 2b constitute three vertexes of an acute-angled triangle. This enables the first identification device 2a and the external identification units 2b to have a larger regional identification scope, which is beneficial to achieve identification without blind region. In this way, after the pickup portion 4 picks up the to-be-identified parcel 3, all sides of the to-be-identified parcel 3 may be identified by the first identification device 2a and the two external identification units 2b; and the position of the pickup portion 4 is not changed or only slightly changed, the parcel information of the to-be-identified parcel 3 may be identified. Therefore, this is beneficial to further improve the operation efficiency.

Of course, in other embodiments not shown, a second identification device may include only one external identification unit, or may include three or more external identification units.

In some embodiments, a first identification device 2a and/or a second identification device include (s) a scanner for scanning identification codes. The scanner may be used to identify the identification codes such as QR codes or bar codes covered on the to-be-identified parcel 3, thus facilitating the identification efficiency and accuracy of the parcel information.

According to the above description, the identification codes regardless of being located on any side of the to-be-identified parcel 3 and any position of the side may be automatically picked up and identified by the parcel identification apparatus. By adopting the parcel identification apparatus, a technical problem in the prior art that the parcel information may be identified only by manually turning over a parcel to make the identification codes upward may be avoided, thereby truly identifying the parcel information without manual intervention and being beneficial to automatically sort the parcel.

This embodiment also provides a parcel sorting apparatus including the parcel identification apparatus. In the parcel sorting apparatus, the parcel identification apparatus is disposed at a sorting inlet of the parcel sorting apparatus, and the automatic sorting apparatus may pick up a to-be-identified parcel at the sorting inlet and identify the parcel information thereof. The pickup portion 4 of the pickup device is used to pick up and hold the parcel 3, and the first identification device 2a and the second identification device are used to identify the parcel information. After the parcel information is identified, the pickup device places the parcel 3 on sorting equipment after a parcel information identification step, such as an automated guided vehicle.

When the parcel identification apparatus of this embodiment is applied to the parcel sorting apparatus, the parcel information of the to-be-identified parcel 3 may be identified as follows:

When the pickup portion 4 of the pickup device picks up the to-be-identified parcel 3, the first identification device 2a on the pickup portion 4 identifies a side that is of the to-be-identified parcel 3 and that faces towards the pickup portion 4, and identifies whether there is corresponding parcel information necessarily identified on the side. If there is the corresponding parcel information, the pickup portion 4 picks up the to-be-identified parcel 3 and transfers the parcel 3 to a next step after the completion of the identification; if there is not the corresponding parcel information, the pickup portion 4 picks up and holds the to-be-identified parcel 3, and then drives the to-be-identified parcel 3 to change the position thereof to adjust the orientation thereof through such movements as rotation, so that the to-be-identified parcel 3 is identified by the second identification device, and then a next step is carried out.

In some embodiments, the parcel sorting apparatus includes a sorting platform and an automated guided vehicle, where the sorting platform includes the sorting inlet and a plurality of sorting outlets. After the parcel identification apparatus picks up and identifies a parcel at the sorting inlet, the pickup portion 4 places the identified parcel on the automated guided vehicle. Then, the automated guided vehicle transports a received parcel to a corresponding sorting outlet according to the identified parcel information.

A parcel identification apparatus according to an embodiment of the present disclosure may identify objects omnidirectionally, and identification marks positioned at different positions on the surface of a to-be-identified parcel may be identified. In comparison with a technology in the prior art that parcel is necessarily turned over to make the bar code thereof face towards a scanner in a manual assistance way, the parcel identification apparatus is more accurate and efficient, thereby being beneficial to achieve automatic and unmanned parcel sorting. The parcel identification apparatus is easy to cooperate with other apparatuses, and achieved in a modern intelligent logistics system in combination with a modern network technology. The parcel sorting apparatus of the present disclosure may achieve full-automatic parcel sorting, thereby improving the sorting efficiency and intelligence level thereof.

Finally, it should be noted that the foregoing embodiments are merely intended for describing the technical solutions of the present disclosure, but not for limiting the present disclosure. Although the present disclosure is described in detail with reference to the preferred embodiments, persons of ordinary skill in the art should understand that they may still make modifications to the specific implementations of the present disclosure or make equivalent replacements to some technical features thereof. Without departing from the spirit of the technical solutions of the present disclosure, the modifications or the equivalent replacements should be covered within the scope of the claimed technical solutions of the present disclosure.

1. A parcel identification apparatus, comprising:
a pickup device, comprising a pickup portion for picking up and holding a to-be-identified parcel, and a first identification device disposed on the pickup portion so as to at least identify parcel information on a side that is of the to-be-identified parcel and that faces towards the pickup portion; and
a second identification device, disposed outside the pickup device so as to at least identify parcel information on other sides that are of the to-be-identified parcel and that are other than the side facing towards the pickup portion.

2. The parcel identification apparatus according to claim 1, wherein the pickup device is configured to enable the position of the to-be-identified parcel held by the pickup portion to be changed, so that the parcel information on the other sides is identified by the second identification device.

3. The parcel identification apparatus according to claim 2, wherein the pickup portion is rotatable around the axis thereof and/or the pickup portion is rotatable around an external axis as a whole, so as to change the position of the to-be-identified parcel held by the pickup portion.

4. The parcel identification apparatus according to claim 1, wherein the first identification device faces towards a holding position where the pickup portion holds the to-be-identified parcel; and/or the first identification device is disposed at the middle of the pickup portion.

5. The parcel identification apparatus according to claim 1, wherein the pickup device comprises a robot, and the pickup portion is a manipulator connected to an arm end of the robot.

6. The parcel identification apparatus according to claim 5, wherein the robot is a six-axis robot.

7. The parcel identification apparatus according to claim 1, wherein the second identification device comprises two external identification units each of which independently identifies parcel information; and the first identification device and the two external identification units constitute three vertexes of an acute-angled triangle.

8. The parcel identification apparatus according to claim 1, wherein the first identification device and/or the second identification device comprise(s) a scanner for scanning identification codes.

9. A parcel sorting apparatus, comprising the parcel identification apparatus according to claim 1, wherein the parcel identification apparatus is disposed at a sorting inlet of the parcel sorting apparatus, so as to pick up a parcel at the sorting inlet and identify parcel information therein.

10. The parcel sorting apparatus according to claim 9, wherein the parcel sorting apparatus comprises a sorting platform, and an automated guided vehicle disposed on the sorting platform; the sorting platform comprises the sorting inlet and a plurality of sorting outlets, and the automated guided vehicle is configured to receive a parcel held by the pickup device and transport the received parcel to a corresponding sorting outlet according to the parcel information of the received parcel identified by the first identification device and/or the second identification device.
